(19) United States
(12) Patent Application Publication
(10) Pub. No.: US 2013/0150469 A1
(43) Pub. Date: Jun. 13, 2013

(54) Flame Retardant Expandable Polystyrene-based Polymerized Beads, and Preparation Method Thereof

(71) Applicant: CHEIL INDUSTRIES INC., Gumi-si (KR)

(72) Inventors: Yu Ho KIM, Uiwang-si (KR); Sang Hyuk KIM, Uiwang-si (KR); Sa Eun CHO, Uiwang-si (KR); Il Jin KIM, Uiwang-si (KR)

(73) Assignee: CHEIL INDUSTRIES INC., Gumi-si (KR)

(21) Appl. No.: 13/761,678

(22) Filed: Feb. 7, 2013

Related U.S. Application Data
(63) Continuation-in-part of application No. PCT/KR2010/009536, filed on Dec. 29, 2010.

(30) Foreign Application Priority Data
Aug. 13, 2010 (KR) 10-2010-0078441

(51) Int. Cl. C08J 9/16

(52) U.S. Cl. CPC C08J 9/16
USPC 521/59

(57) ABSTRACT

A method of making flame retardant expandable polystyrene-based polymerized beads includes: mixing (a) about 70 to about 95 wt % of a styrene monomer, (b) about 1 to about 10 wt % of a char-generating thermoplastic resin, and (c) about 4 to about 29 wt % of inorganic foam particles to prepare a dispersion; and polymerizing the dispersion. The method of the present invention can eliminate further processing steps, can exhibit excellent productivity, and can allow easy control of the size of the beads.

### CROSS-REFERENCE TO RELATED APPLICATIONS

This application is a continuation-in-part of International Application No. PCT/KR2010/009536 filed on Dec. 29, 2010, pending, which designates the U.S., published as WO 2012/020894, and is incorporated herein by reference in its entirety, and claims priority therefrom under 35 USC Section 120. This application also claims priority under 35 USC Section 119 to and the benefit of Korean Patent Application No. 10-2010-0078441 filed on Aug. 13, 2010, the entire disclosure of which is incorporated herein by reference.

### FIELD OF THE INVENTION

The present invention relates to flame retardant expandable polystyrene-based polymerized beads and a preparation method thereof.

### BACKGROUND OF THE INVENTION

Generally, foam molded articles of expandable polystyrene can exhibit high strength, light weight, buffering, waterproofing, heat retention and thermal insulation properties and thus are used as packaging materials for home appliances, boxes for agricultural and fishery products, buoys, thermal insulation materials for housing and the like. Seventy percent or more of domestic expandable polystyrene is directed to thermal insulation materials for housing or cores of sandwich panels.

However, in recent years, the use of such expandable polystyrenes has been restricted since they are being blamed for fires. Thus, in order for the expandable polystyrenes to be employed as thermal insulation materials for houses and the like, it is necessary for the expandable polystyrenes to have flame retardancy at the level of flame retardant materials.

Korea Patent No. 0602205 discloses a method of preparing incombustible flame retardant polystyrene foam particles by coating expanded graphite, a thermosetting resin and a curing catalyst onto polystyrene foam particles and curing the resultant coated particles.

Korea Patent No. 0602196 discloses a method of preparing flame retardant polystyrene foam particles, which includes coating a metal hydroxide compound selected from the group consisting of aluminum hydroxide (Al(OH)₃), magnesium hydroxide (Mg(OH)₂) and mixtures thereof, a thermosetting liquid phenol resin, and a curing catalyst for the phenol resin onto polystyrene foam particles and crosslinking the resultant coated particles.

In these patents, the surfaces of expandable beads are cross-linked with a thermosetting resin, which inhibits secondary expansion of the beads by steam. Accordingly, these methods can decrease strength and fusion between particles in the course of manufacturing molded articles (panels). Furthermore, these methods can cause environmental pollution due to the use of thermosetting resins, such as phenol, melamine and the like; they can require additional facility investment to coat thermosetting resins or inorganic materials; and they can cause deterioration in physical properties of resins due to the use of the inorganic materials.

Therefore, there is a need for a method of preparing flame retardant polystyrene foam resin capable of inhibiting fusion and decrease of strength between particles while preventing environmental pollution in the course of manufacturing molded articles.

### SUMMARY OF THE INVENTION

The present invention relates to flame retardant expandable polystyrene-based polymerized beads. The flame retardant expandable polystyrene-based polymerized beads may not have inherent self-extinguishable flame retardancy yet can have good flame retardancy, for example, flame retardancy greater than that of inherently flame retardant materials as measured in accordance with KS F ISO 5660-1.

The flame retardant expandable polystyrene-based polymerized beads can be readily processed with excellent productivity and/or without requiring any separate processes and thus can be produced with no or minimal facility investment and/or with no or minimal environmental pollution.

The flame retardant expandable polystyrene-based polymerized beads can also exhibit good thermal insulation and excellent mechanical strength.

The flame retardant expandable polystyrene-based polymerized beads also can permit easy size adjustment by controlling polymerization.

Still further the flame retardant expandable polystyrene-based polymerized beads can have an increased content of carbon particles.

The present invention also provides flame retardant polystyrene foam produced using the flame retardant expandable polystyrene-based polymerized beads. The flame retardant polystyrene foam produced using the flame retardant expandable polystyrene-based polymerized beads can exhibit a good balance of physical properties such as flame retardancy, thermal conductivity and mechanical strength and can be suitable for use in a sandwich panel.

The present invention also provides a method of making the flame retardant expandable polystyrene-based polymerized beads. The method includes: mixing (a) about 70 wt % to about 95 wt % of a styrene monomer, (b) about 1 wt % to about 10 wt % of a char-generating thermoplastic resin and (c) about 4 wt % to about 29 wt % of inorganic foam particles to prepare a dispersion liquid; and polymerizing the dispersion liquid.

In one embodiment, the method may further include adding a foaming agent to the dispersion liquid before polymerization of the dispersion liquid.

In another embodiment, the method may further include adding a foaming agent to the dispersion liquid during polymerization of the dispersion liquid.

In a further embodiment, the method may further include adding a foaming agent to the dispersion liquid after polymerization of the dispersion liquid.

The foaming agent may be added in an amount of about 3 to about 8 parts by weight based on about 100 parts by weight of components (a)+(b)+(c).

In one embodiment, the char-generating thermoplastic resin (b) may contain an oxygen bond, an aromatic moiety, or a combination thereof in the backbone thereof.

In one embodiment, the char-generating thermoplastic resin (b) may include polycarbonate, polyphenylene ether, polyurethane, polyphenylene sulfide, polyester, and/or polyimide resins.

In another embodiment, the char-generating thermoplastic resin (b) may include polycarbonate, polyphenylene ether, and/or polyurethane resins.

The inorganic foam particles (c) may include expanded graphite, silicate, perlite and/or white sand particles.

The inorganic foam particles (c) may have an average particle diameter of about 10 μm to about 1,000 μm and an expansion temperature of about 150° C. or more.

The dispersion liquid may further include at least one additive selected from the group consisting of anti-blocking agents, nucleating agents, antioxidants, carbon particles, fillers, antistatic agents, plasticizers, pigments, dyes, heat stabilizers, UV absorbents, flame retardants, peroxide initiators, suspension stabilizers, foaming agent, chain-transport agents, expansion aids, and the like, and combinations thereof.

The present invention also provides flame retardant expandable polystyrene-based polymerized beads prepared by the method. The beads may have an average particle diameter of about 0.5 mm to about 3 mm.

In another embodiment, the beads may be polystyrene-based polymerized beads formed by polymerizing (a) about 70 wt % to about 95 wt % of a styrene monomer, (b) about 1 wt % to about 10 wt % of a char-generating thermoplastic resin and (c) about 4 wt % to about 29 wt % of inorganic foam particles, wherein the polymerized beads are impregnated with about 3 to about 8 parts by weight of a foaming agent based on about 100 parts by weight of components (a)+(b)+(c).

The present invention also relates to flame retardant polystyrene-based foam produced by expanding the polymerized beads. The foam may have a residual layer thickness of about 10 mm or more when measured after heating a 50 mm thick sample at 50 kW/m² of radiation heat from a cone heater in accordance with KS F ISO 5560-1.

The foam may have a density of about 5 g/l to about 100 g/l.

The present invention provides flame retardant expandable polystyrene-based polymerized beads and a preparation method thereof, which may have good flame retardancy above flame retardant materials according to KS F ISO 5660-1 instead of self-extinguishable flame retardancy, excellent productivity without any separate processes, exhibit good flame retardancy, thermal insulation and excellent mechanical strength, may be manufactured with minimal facility investment without causing any environmental pollution, have good processability, permit easy size adjustment by controlling polymerization, and have an increased content of carbon particles. Further, the present invention provides flame retardant polystyrene foam produced using the flame retardant expandable polystyrene-based polymerized beads and suitable for a sandwich panel by ensuring outstanding balance of physical properties such as flame retardancy, thermal conductivity and mechanical strength.

### DETAILED DESCRIPTION OF THE INVENTION

The present invention now will be described more fully hereinafter in the following detailed description of the invention, in which some, but not all embodiments of the invention are described with reference to the accompanying drawings. Indeed, this invention may be embodied in many different forms and should not be construed as limited to the embodiments set forth herein; rather, these embodiments are provided so that this disclosure will satisfy applicable legal requirements.

Flame retardant expandable polystyrene polymerized beads according to the present invention are formed by polymerization of (a) a styrene monomer, (b) a char-generating thermoplastic resin, and (c) inorganic foam particles.

In one embodiment, the flame retardant expandable polystyrene polymerized beads may be prepared by mixing (a) about 70 wt % to about 95 wt % of a styrene monomer, (b) about 1 wt % to about 10 wt % of a char-generating thermoplastic resin, and (c) about 4 wt % to about 29 wt % of inorganic foam particles to prepare a dispersion liquid; and suspension-polymerizing the dispersion liquid.

(a) Styrene Monomer

Examples of the styrene monomer may include without limitation styrene, α-methyl styrene, p-methyl styrene, and the like. These may be used alone or in combination of two or more thereof. In exemplary embodiments, styrene may be used.

In some embodiments, the styrene monomer may be a mixture of styrene and another ethylenic unsaturated monomer. Examples of the ethylenic unsaturated monomer may include without limitation C1-C10 alkyl styrene such as α-methyl styrene, divinylbenzene, acrylonitrile, diphenyl ether, and the like, and combinations thereof.

In exemplary embodiments, the styrene monomer may include a mixture of about 80 wt % to about 100 wt % of styrene and about 0 to about 20 wt % of an ethylenic unsaturated monomer.

In some embodiments, the mixture of styrene and ethylenic unsaturated monomer may include styrene in an amount of about 80, 81, 82, 83, 84, 85, 86, 87, 88, 89, 90, 91, 92, 93, 94, 95, 96, 97, 98, 99, or 100 wt %. Further, according to some embodiments of the present invention, the amount of styrene can be in a range from about any of the foregoing amounts to about any other of the foregoing amounts.

In some embodiments, the mixture of styrene and ethylenic unsaturated monomer may include ethylenic unsaturated monomer in an amount of 0 (the ethylenic unsaturated monomer is not present), about 0 (the ethylenic unsaturated monomer is present), 1, 2, 3, 4, 5, 6, 7, 8, 9, 10, 11, 12, 13, 14, 15, 16, 17, 18, 19, or 20 wt %. Further, according to some embodiments of the present invention, the amount of ethylenic unsaturated monomer can be in a range from about any of the foregoing amounts to about any other of the foregoing amounts.

The styrene monomer (a) may be present in an amount of about 70 wt % to about 95 wt % based on 100 wt % of (a)+(b)+(c). In some embodiments, the styrene monomer (a) may be present in an amount of about 70, 71, 72, 73, 74, 75, 76, 77, 78, 79, 80, 81, 82, 83, 84, 85, 86, 87, 88, 89, 90, 91, 92, 93, 94, or 95 wt %. Further, according to some embodiments of the present invention, the amount of styrene monomer (a) can be in a range from about any of the foregoing amounts to about any other of the foregoing amounts.

(b) Char-Generating Thermoplastic Resin

The char-generating thermoplastic resin (b) may include an oxygen bond, an aromatic moiety, or both in the backbone thereof.

Examples of the char-generating thermoplastic resin (b) may include without limitation polycarbonate resins, polyphenylene ether resins, polyurethane resins, and the like. These resins may be used alone or in combination of two or more thereof. Other examples of the char-generating thermoplastic resin (b) may include without limitation polyphenylene sulfide (PPS) resins, polyester resins such as polyethylene terephthalate (PET) and polycyclohexane terephthalate (PCT) resins, polyimide resins, and the like. These resins may also be used alone or in combination of two or more thereof.

In exemplary embodiments, the polycarbonate may have a weight average molecular weight of about 10,000 g/mol to about 30,000 g/mol, for example about 15,000 g/mol to about 25,000 g/mol.

Examples of the polyphenylene ether may include without limitation poly(2,6-dimethyl-1,4-phenylene)ether, poly(2,6-diethyl-1,4-phenylene)ether, poly(2,6-dipropyl-1,4-phenylene)ether, poly(2-methyl-6-ethyl-1,4-phenylene)ether, poly(2-methyl-6-propyl-1,4-phenylene)ether, poly(2-ethyl-6-propyl-1,4-phenylene)ether, poly(2,6-diphenyl-1,4-phenylene)ether, copolymers of poly(2,6-dimethyl-1,4-phenylene)ether and poly(2,3,6-trimethyl-1,4-phenylene)ether, copolymers of poly(2,6-dimethyl-1,4-phenylene)ether and poly(2,3,5-triethyl-1,4-phenylene)ether, and the like, and combinations thereof. In exemplary embodiments, a copolymer of poly(2,6-dimethyl-1,4-phenylene)ether and poly(2,3,6-trimethyl-1,4-phenylene)ether, poly(2,6-dimethyl-1,4-phenylene)ether, or a combination thereof, for example, poly(2,6-dimethyl-1,4-phenylene)ether, can be used.

The polyphenylene ether may have an intrinsic viscosity of about 0.2 to about 0.8 dl/g, as measured in chloroform as a solvent at 25° C., to have good thermal stability and workability.

Due to high glass transition temperature, the polyphenylene ether may provide much higher thermal stability when mixed with the styrene resin, and may be mixed with the styrene resin in any ratio.

The thermoplastic polyurethane may be prepared through reaction of a diisocyanate with a diol compound, and may include a chain-transfer agent, as needed. Examples of diisocyanates may include without limitation aromatic, aliphatic and/or alicyclic diisocyanate compounds. Examples of the diisocyanates may include without limitation 2,4-tolylene diisocyanate, 2,6-tolylene diisocyanate, phenylene diisocyanate, 4,4′-diphenyl methane diisocynate, 4,4′-diphenyl diisocynate, 1,5-naphthalene diisocynate, 3,3′-dimethylbihenyl-4,4′-diisocynate, o-, m- and/or p-xylene diisocyanate, tetramethylene diisocyanate, hexamethylene diisocyanate, trimethyl hexamethylene diisocyanate, dodecanemethylene diisocyanate, cyclohexane diisocyanate, dicyclohexylmethane diisocyanate, and the like, and combinations thereof.

Examples of the diol compounds may include without limitation polyester diols, polycaprolactone diols, polyether diols, polycarbonate diols, and the like, and combinations thereof. For example, mention can be made of ethylene glycol, 1,2-propylene glycol, 1,3-propylene glycol, butane 1,2-diol, butane 1,3-diol, butane 1,4-diol, butane 2,3-diol, butane 2,4-diol, hexane diol, trimethylene glycol, tetramethylene glycol, hexene glycol and propylene glycol, polytetramethylene ether glycol, dihydroxy polyethylene adipate, polyethylene glycol, polypropylene glycol, and the like, and combinations thereof, without being limited thereto.

In the present invention, the char-generating thermoplastic resin (b) may be present in an amount of about 1 wt % to about 10 wt %, for example about 1 wt % to about 5 wt %, and as another example about 2 wt % to about 3.5 wt %, based on 100 wt % of (a)+(b)+(c). In some embodiments, the char-generating thermoplastic resin (b) may be present in an amount of about 1, 1.5, 2, 2.5, 3, 3.5, 4, 4.5, 5, 5.5, 6, 6.5, 7, 7.5, 8, 8.5, 9, 9.5 or 10% by weight by weight. Further, according to some embodiments of the present invention, the amount of char-generating thermoplastic resin (b) can be in a range from about any of the foregoing amounts to about any other of the foregoing amounts.

If the amount of the char-generating thermoplastic resin (b) is less than about 1 wt %, flame retardancy can be decreased as a result of decrease of char generation. If the amount of the char-generating thermoplastic resin (b) is greater than about 10 wt %, mechanical properties can be decreased due to high glass transition temperature in preparation of thermal insulation materials.

(c) Inorganic Foam Particles

Examples of the inorganic foam particles may include without limitation expanded graphite, silicate, perlite, white sand particles, and the like, and combinations thereof.

In the present invention, the inorganic foam particles may act as char formers. Accordingly, it is necessary for the inorganic foam particles to maintain their shape without collapsing upon melt extrusion with resins and to have a uniform size in order to provide desired flame retardancy, mechanical strength, and thermal conductivity

The inorganic foam particles (c) may have an average particle diameter of about 10 μm to about 1,000 μm, for example about 100 μm to about 750 μm, and as another example about 150 μm to about 500 μm. Within this range, the inorganic foam particles can act as char formers, thereby providing desired flame retardancy, mechanical strength, and thermal conductivity.

Such expanded graphite having a smaller particle size as the inorganic foam particles can provide good stability of the suspension while significantly reducing the content of water contained therein, as compared with expanded graphite having a greater particle size.

The expanded graphite may be prepared by inserting chemical species capable of being inserted into interlayers into layered crystal structures of graphite and then subjecting the same to heat or microwave. In one embodiment, the expanded graphite may be prepared by treating graphite with an oxidizing agent in order to introduce chemical species, such as SO₃²⁻ and NO₃⁻, between the graphite layers to form interlayer compounds, rapidly subjecting the graphite having interlayered compounds formed therein to heat or microwave to gasify the chemical species bonded between interlayers, and then expanding the graphite using pressure resulted from gasification hundreds to thousands of times. Those expanded graphite can be commercially available ones.

The expanded graphite can expand at a temperature of about 150° C. or more, for example about 250° C. or more, as another example at about 300° C. or more, and as yet another example from about 310° C. to about 900° C. When the expanded graphite capable of expansion at about 150° C. or more is employed, it the expanded graphite particles can act as char formers since the expanded graphite particles are not deformed or collapsed upon polymerization.

The silicates may be organically modified layered silicates, and examples thereof may include without limitation sodium silicate, lithium silicate, and the like, and combinations thereof. In the present invention, the silicate may generate char to form a blocking membrane, which may maximize flame retardancy.

Clays such as smectites, kaolinites, illites, and the like and combinations thereof may be organically modified and used as the organically modified layered silicates. Examples of clays include without limitation montmorillonites, hectorites, saponites, vermiculites, kaolinites, hydromicas, and the like and combinations thereof. Examples of modifying agents for organizing the clays include without limitation alkylamine salts, organic phosphates, and the like, and combinations thereof. Examples of alkylamine salts may include without limitation didodecyl ammonium salt, tridodecyl ammonium salt, and the like, and combinations thereof. Examples of organic phosphates may include without limitation tetrabutyl phosphate, tetraphenyl phosphate, triphenyl hexadecyl phosphate, hexadecyl tributyl phosphate, methyl triphenyl phosphate, ethyl triphenyl phosphate, and the like, and combinations thereof.

The alkylamine salts and/or organic phosphates may be substituted with interlayered metal ions of layered silicates to broaden the interlayer distance, which can provide layered silicates compatible with organic materials and capable of being kneaded with resins.

In one embodiment, montmorillonite modified by a C₁₂-C₂₀ alkyl amine salt may be used as the organically modified layered silicates. In some embodiments, the organically modified montmorillonite (hereinafter referred to as “m-MMT”) may be organized at its interlayer with dimethyl dehydrogenated tallow ammonium instead of Na⁺.

The perlite may be heat-treated expanded perlite. The expanded perlite may be prepared by heating perlite at a temperature of about 870 to about 1100° C. to vaporize volatile components including moisture together with generation of vaporizing pressure, thereby expanding each granule by about 10 to about 20 times via the vaporizing pressure to form round, glassy particles.

In one embodiment, the expanded perlite may have a specific gravity of about 0.04 g/cm² to about 0.2 g/cm². Within this range, the perlite may exhibit good dispersion.

The white sand particles may be expandable (foamable) white sand particles.

In the present invention, the inorganic foam particles (c) may be present in an amount of about 4 wt % to about 29 wt %, for example about 8 wt % to about 25 wt %, and as another example about 10 wt % to about 20 wt %, based on 100 wt % of (a)+(b)+(c). In some embodiments, the inorganic foam particles (c) may be present in an amount of about 4, 5, 6, 7, 8, 9, 10, 11, 12, 13, 14, 15, 16, 17, 18, 19, 20, 21, 22, 23, 24, 25, 26, 27, 28, or 29 wt %. Further, according to some embodiments of the present invention, the amount of inorganic foam particles (c) can be in a range from about any of the foregoing amounts to about any other of the foregoing amounts.

If the amount of the inorganic foam particles exceeds about 29 wt %, polymerization stability can be deteriorated. If the amount of the inorganic foam particles is less than about 4 wt %, flame retardancy can be deteriorated.

After preparing the dispersion liquid by mixing (a) the styrene monomer, (b) the char-generating thermoplastic resin and (c) the inorganic foam particles, polymerization of the dispersion liquid is carried out.

The polymerization may be suspension polymerization. In this case, the method may further include adding a foaming agent before, during and/or after polymerization of the dispersion liquid.

The foaming agent may be any foaming agent well known to those skilled in the art. Examples of the foaming agents may include without limitation C₃-C₆ hydrocarbons, such as propane, butane, isobutene, n-pentane, isopentane, neopentane, cyclopentane, hexane and cyclohexane; halogenated hydrocarbons, such as trichlorofluoromethane, dichlorofluoromethane, and dichlorotetrafluoroethane; and the like, and combinations thereof. Butane, pentane and/or hexane may be used in exemplary embodiments.

In the present invention, the foaming agent may be present in an amount of about 3 parts by weight to about 8 parts by weight based on about 100 parts by weight of (a)+(b)+(c). In some embodiments, the foaming agent may be present in an amount of about 3, 4, 5, 6, 7, or 8 parts by weight. Further, according to some embodiments of the present invention, the amount of foaming agent can be in a range from about any of the foregoing amounts to about any other of the foregoing amounts.

When the foaming agent is used in an amount within this range, good processability can be ensured.

The flame retardant expandable polystyrene-based polymerized beads may further include one or more conventional additives, which can be added to the dispersion liquid. Examples of the additives include without limitation anti-blocking agents, nucleating agents, antioxidants, carbon particles, fillers, antistatic agents, plasticizers, pigments, dyes, heat stabilizers, UV absorbers, flame retardants, and the like. The additives may be used alone or in combination of two or more thereof.

During suspension polymerization, conventional aids, for example, peroxide initiators, suspension stabilizers, foaming agents, chain-transport agents, expansion aids, nucleating aids, and the like, and combinations thereof may be added. These aids may be contained in the dispersion liquid.

The anti-blocking agent may be optionally used to provide adhesion between particles upon foaming or to facilitate fusion between particles upon preparation of thermal insulation materials. Examples of the anti-blocking agent may include without limitation one or more copolymers of ethylene-vinyl acetate.

Examples of the nucleating agents may include without limitation one or more polyethylene waxes.

Examples of the flame retardants may include without limitation phosphor flame retardants, such as tris(2,3-dibromopropyl)phosphate, triphenylphosphate, bisphenol A diphenyl phosphate and the like, halogen flame retardants, such as hexabromocyclododecane, tribromophenyl allylether, and the like, and combinations thereof. In exemplary embodiments, bisphenol A diphenylphosphate may be used.

A suspension stabilizer may also be used. Examples of suspension stabilizers include without limitation inorganic pickering dispersing agents, for example, magnesium pyrophosphate and/or calcium phosphate.

In this way, essentially round beads having a particle size of about 0.5 mm to about 3 mm can be prepared through polymerization.

Further, in one embodiment, the polymerized beads may be coated with a coating agent. Examples of coating agents include without limitation metal stearates, glycerol esters, fine silicate particles, and the like, and combinations thereof.

The present invention also provides flame retardant polystyrene foam prepared using the flame retardant expandable polystyrene-based polymerized beads.

The foam prepared from the flame retardant expandable polystyrene-based polymerized beads may be obtained as a molded article by pre-expanding and melt-bonding the polymerized beads. Pre-expansion may be carried out by heating the beads with steam.

In one embodiment, the pre-expanded particles are introduced into a non-closed mold and brought into contact with steam. The molded article can be removed from the mold after cooling.

The foam produced using the flame retardant expandable polystyrene beads may have a residual layer thickness of about 10 mm or more, for example about 11 mm to about 45 mm, when measured after heating a 50 mm thick sample at 50 kW/m² using a cone heater for 5 minutes in accordance with KS F ISO 5560-1.

The foam according to the present invention may be employed as packaging materials for home appliances, boxes for agricultural and fishery products, thermal insulation materials for houses, and the like. Further, the foam can have good flame retardancy, mechanical strength and thermal insulation, and thus may be suitably used as thermal insulation materials for house and cores of sandwich panels manufactured by inserting thermal insulation core between iron plates.

Hereinafter, the constitution and functions of the present invention will be explained in more detail with reference to the following examples. It should be understood that these examples are provided for illustration only and are not to be in any way construed as limiting the present invention.

### EXAMPLES

### Example 1

To a reactor, 82 parts by weight of a styrene monomer, 3 parts by weight of polyphenylene ether (PX100F, MEP Co., Ltd.), 15 parts by weight of expanded graphite having an average particle size of 180 μm or more (MPH803, ADT Co., Ltd.), and 0.3 parts by weight of benzoyl peroxide as an initiator, 0.1 parts by weight of t-butylperoxybenzoate, 0.55 parts by weight of hexabromocyclododecane, and 0.01 parts by weight of sodium alkyl benzene sulfonate are added and stirred for 60 minutes. Then, 100 parts by weight of deionized water, and 0.3 parts by weight of tricalcium phosphate as a dispersing agent are added to a 100 L reactor, followed by stirring for 30 minutes. After introducing the organic phase into the 100 L reactor, the suspension is rapidly heated to 90° C. and maintained for 4 hours. Then, 8 parts by weight of pentane mixed gas is added to the mixture and maintained at 125° C. for 6 hours to produce expandable polystyrene beads. After drying for 5 hours, the coated expandable polystyrene beads are placed in a plate molder and subjected to a steam pressure of 0.5 kg/cm² to obtain a foam molded article. The foam molded article is dried in a desiccator at 50° C. for 24 hours and cut to prepare specimens for measuring flame retardancy, thermal conductivity and mechanical strength.

The physical properties of the prepared specimens are measured in a manner described below.

Methods for Measuring Physical Properties

(1) Flame retardancy: Flame retardancy is evaluated according to KS F ISO 5660-1 for testing incombustibility of internal finish materials and structure for buildings. A core sample of a size of 100 mm×100 mm×50 mm is manufactured and heated for 5 minutes to determine whether cracking occurred and to determine the residual layer thickness (mm). Further, gas toxicity testing is also performed.

(2) Thermal conductivity (W/m·K): Thermal conductivity is measured by a method for measuring thermal conductivity of heat keeping materials as prescribed in KS L9016 when the sample has a specific gravity of 30 kg/m³.

(3) Compressive strength (N/cm²): Compressive strength is measured by a method for measuring compressive strength of foam polystyrene heat keeping materials as prescribed in KS M 3808 when the sample has a specific gravity 30 kg/m³.

(4) Flexural strength (N/cm²): Flexural strength is measured by a method for measuring flexural strength of foam polystyrene heat keeping materials as prescribed in KS M 3808 when the sample has a specific gravity of 30 kg/m³.

### Example 2

Specimens are prepared in the same manner as in Example 1 except that 5 parts by weight of polyphenylene ether (PX100F, MEP Co., Ltd.) is added as a char-generating thermoplastic resin upon polymerization, instead of 3 parts by weight of polyphenylene ether.

### Example 3

Specimens are prepared in the same manner as in Example 1 except that 20 parts by weight of expanded graphite having an average particle size of 180 μm or more (MPH803, ADT Co., Ltd.) is added as inorganic foam particles and 3 parts by weight of polycarbonate (SC-1620, Cheil Industry Co., Ltd.) having an index of fluidity of 10.5 g/10 min ((250° C., 12 kg) is added as a char-generating thermoplastic resin upon polymerization.

### Example 4

Specimens are prepared in the same manner as in Example 1 except that 20 parts by weight of expanded graphite having an average particle size of 180 μm or more (MPH803, ADT Co., Ltd.) is used as inorganic foam particles and 5 parts by weight of polycarbonate (SC-1620, Cheil Industry Co., Ltd.) having an index of fluidity of 10.5 g/10 min (250° C., 12 kg) is used as a char-generating thermoplastic resin upon polymerization.

### Comparative Example 1

Specimens are prepared in the same manner as in Example 1 except that 2 parts by weight of expanded graphite is used upon polymerization. In flame retardancy testing according to KS F ISO 5660-1 for testing incombustibility of internal finish materials and structure for buildings, the specimens have substantially no residual layer and cracking since heat transfer is not prevented due to lack of an expanded carbon layer upon combustion. Thus, the specimen did not exhibit performance of flame retardant materials.

### Comparative Example 2

Specimens are prepared in the same manner as in Example 1 except that polycarbonate (SC-1620, Cheil Industry Co., Ltd.) having an index of fluidity of 10.5 g/10 min (250° C., 12 kg) is used as a char-generating thermoplastic resin upon polymerization. In flame retardancy testing according to KS F ISO 5660-1, the specimen has substantially no residual layer and cracking occurred in the specimen since heat transfer is not prevented due to lack of an expanded carbon layer upon combustion.

### Comparative Example 3

Specimens are prepared in the same manner as in Example 1 except that 0.1 parts by weight of polyphenylene ether (PX100F, MEP Co., Ltd.) is added as a char-generating thermoplastic resin upon polymerization.

### Comparative Example 4

Specimens are prepared in the same manner as in Comparative Example 3 except that polycarbonate (SC-1620, Cheil Industry Co., Ltd.) having an index of fluidity of 10.5 g/10 min (250° C., 12 kg) is used as a char-generating thermoplastic resin upon polymerization.

TABLE 1

| | | Example | | | | Comparative Example | | | |
|---|---|---|---|---|---|---|---|---|---|
| | | 1 | 2 | 3 | 4 | 1 | 2 | 3 | 4 |
| (a) | | 82 | 80 | 77 | 75 | 95 | 95 | 84.9 | 84.9 |
| (b) | PPE | 3 | 5 | — | — | 3 | — | 0.1 | — |
| | PC | — | — | 3 | 5 | — | 3 | — | 0.1 |
| (c) | | 15 | 15 | 20 | 20 | 2 | 2 | 15 | 15 |

| | | | | | | | | |
|---|---|---|---|---|---|---|---|---|
| Flame retardancy | 12 | 13 | 15 | 17 | 0 | 0 | 12 | 11 |
| (Thickness of | | | | | | | | |
| residual layer | | | | | | | | |
| (mm)) | | | | | | | | |
| Occurrence of | No cracking | No cracking | No cracking | No cracking | Cracking | Cracking | Cracking | Cracking |
| cracking | | | | | | | | |
| Heat | 0.032 | 0.033 | 0.033 | 0.033 | 0.033 | 0.034 | 0.033 | 0.034 |
| conductivity | | | | | | | | |
| Compressive | 18.8 | 18.3 | 18.0 | 18.0 | 17.8 | 18.0 | 18.1 | 17.9 |
| strength | | | | | | | | |
| Flexural strength | 37.2 | 37.1 | 37.2 | 37.2 | 37.1 | 37.2 | 37.1 | 37.2 |

As shown in Table 1, based on the flame retardancy testing according to KS F ISO 5660-1, the specimens of Examples 1 to 4 have flame retardancy by allowing the carbon layer expanded upon combustion to act as an insulating layer obstructing heat transfer to a rear side to thereby form a residual layer having a thickness of 12 mm or more upon completion of combustion. In addition, these specimens have superior mechanical strength and insulating properties to those of the comparative examples.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A method of preparing flame retardant expandable polystyrene-based polymerized beads, comprising:
mixing (a) about 70 wt % to about 95 wt % of a styrene monomer, (b) about 1 wt % to about 10 wt % of a char-generating thermoplastic resin and (c) about 4 wt % to about 29 wt % of inorganic foam particles to prepare a dispersion liquid; and
polymerizing the dispersion liquid.

2. The method according to claim 1, further comprising: adding a foaming agent to the dispersion liquid before polymerization of the dispersion liquid.

3. The method according to claim 1, further comprising: adding a foaming agent to the dispersion liquid during polymerization of the dispersion liquid.

4. The method according to claim 1, further comprising: adding a foaming agent to the dispersion liquid after polymerization of the dispersion liquid.

5. The method according to claim 2, wherein the foaming agent is added in an amount of about 3 to about 8 parts by weight based on about 100 parts by weight of (a)+(b)+(c).

6. The method according to claim 3, wherein the foaming agent is added in an amount of about 3 to about 8 parts by weight based on about 100 parts by weight of (a)+(b)+(c).

7. The method according to claim 4, wherein the foaming agent is added in an amount of about 3 to about 8 parts by weight based on about 100 parts by weight of (a)+(b)+(c).

8. The method according to claim 1, wherein the char-generating thermoplastic resin (b) includes an oxygen bond, an aromatic moiety or a combination thereof in a backbone thereof.

9. The method according to claim 1, wherein the char-generating thermoplastic resin (b) comprises polycarbonate resin, polyphenylene ether resin, polyurethane resin, polyphenylene sulfide resin, polyester resin, polyimide resin, or a combination thereof.

10. The method according to claim 9, wherein the char-generating thermoplastic resin (b) comprises polycarbonate resin, polyphenylene ether resin, polyurethane resin or a combination thereof.

11. The method according to claim 1, wherein the inorganic foam particles (c) comprise expanded graphite, silicate, perlite, white sand particles, or a combination thereof.

12. The method according to claim 1, wherein the inorganic foam particles (c) have an average particle diameter of about 10 μm to about 1,000 μm and an expansion temperature of about 150° C. or more.

13. The method according to claim 1, wherein the dispersion liquid further comprises at least one additive selected from the group consisting of anti-blocking agents, nucleating agents, antioxidants, carbon particles, fillers, antistatic agents, plasticizers, pigments, dyes, heat stabilizers, UV absorbents, flame retardants, peroxide initiators, suspension stabilizers, foaming agent, chain-transport agents, expansion aids, and combinations thereof.

14. Flame retardant expandable polystyrene-based polymerized beads prepared by the method according to claim 1 and having an average particle diameter of about 0.5 mm to about 3 mm.

15. Flame retardant expandable polystyrene-based polymerized beads formed by polymerizing (a) about 70 wt % to about 95 wt % of a styrene monomer, (b) about 1 wt % to about 10 wt % of a char-generating thermoplastic resin and (c) about 4 wt % to about 29 wt % of inorganic foam particles, wherein the polymerized beads are impregnated with about 3 to about 8 parts by weight of a foaming agent based on about 100 parts by weight of (a)+(b)+(c).

16. Flame retardant polystyrene-based foam produced by expanding the polymerized beads according to claim 14 and having a residual layer thickness of about 10 mm or more when measured after heating a 50 mm thick sample at 50 kW/m² of radiation heat from a cone heater in accordance with KS F ISO 5560-1.

17. The flame retardant polystyrene-based foam according to claim 16, wherein the foam has a density of about 5 to about 100 g/l.
